(19) United States
(12) Patent Application Publication
(10) Pub. No.: US 2009/0045932 A1
(43) Pub. Date: Feb. 19, 2009

(54) Motor Vehicle Comprising a Warning Device

(75) Inventor: Jochen Petersen, Winsen/Luhe (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 11/793,533

(22) PCT Filed: Nov. 11, 2005
(86) PCT No.: PCT/EP05/12124

§ 371 Date: Apr. 1, 2008

(30) Foreign Application Priority Data
Dec. 23, 2004 (DE) 10 2004 063 351.7

(51) Int. Cl. B60Q 1/50

(52) U.S. Cl. 340/467

(57) ABSTRACT

A motor vehicle has a warning device for drivers of vehicles traveling behind in situations with strong braking deceleration. This warning device exhibits a warning signal transmitter, preferably formed by flashing indicators, a sensor for sensing the situation with strong braking deceleration and which is formed by the sensor for sensing an emergency braking situation of a braking assistance device, and a control unit for controlling the warning device, which is preferably embodied with the control device for controlling the braking assistance device as a common control unit, in particular in a common housing. This warning device proves very robust, very secure, and reliable in its operation.

### BACKGROUND AND SUMMARY OF THE INVENTION

This invention relates to a motor vehicle having a warning device, in particular for the drivers of vehicles traveling behind in situations with strong braking deceleration.

According to DMV manual conditions, motor vehicles are equipped with flashing hazard indicator lights, which inform the following traffic, or other traffic, that the vehicle is immobile. These flashing hazard indicator lights are also used to inform vehicles traveling behind about a traffic jam lying ahead. To do this, the driver of the vehicle activates the flashing hazard indicator system manually.

Furthermore, according to DMV manual rules, motor vehicles are equipped with brake lights which warn the drivers of vehicles traveling behind when the brake is actuated. Since the illumination of the brake lights does not inform those drivers about the specific value of the braking deceleration, German document DE 43 02 477 A1 proposes measuring braking deceleration by an acceleration sensor, and then activating a warning device, which comprises, for example, the rear headlights, an additional light, the flashing hazard indicator light system, or an illuminated number plate if the measured braking deceleration value is above a defined threshold value. This warning device proves costly and susceptible to faults.

Furthermore, vehicles with braking assistants are known. In emergency situations, in which full braking occurs, the braking assistance device is intended to intervene to provide help and to bring about the maximum boosting of the braking force with a minimum braking distance so that the problems of many drivers in emergency situations, specifically that they react quickly but overall depress the brake pedal much too weakly or with too much hesitation, are overcome.

A braking assistance device includes, in addition to the master brake cylinder with a partial vacuum brake booster, a travel sensor, a switching magnet, a release switch and a control unit. The travel sensor senses both the pedal movement and the diaphragm movement of the brake booster. If a high activation speed (emergency braking) of the pedal or of the diaphragm movement is detected, the control unit actuates the switching magnet and full braking occurs even if the pedal pressure applied by the driver would not be sufficient to bring about full braking. After the brake pedal has been completely released, the release switch switches off the switching magnet, as a result of which the brake boosting and the braking process are ended. The braking assistance devices permit very effective deceleration of motor vehicles to be brought about and thus reduce the frequency of accidents as a result of rear end collisions with vehicles traveling in front. In contrast, if vehicles are traveling too close to one another, critical driving situations can occur behind the vehicle with the braking assistance device as a result of a rear end collision.

This invention is based on the problem of specifying an effective warning device for a motor vehicle which reliably and safely warns, in particular, drivers of vehicles traveling behind in a situation with strong braking deceleration.

The problem according to the invention is achieved by way of a motor vehicle having a warning device as claimed.

Advantageous developments are also claimed.

### DESCRIPTION OF THE INVENTION

Contrary to the known prior art, the invention does not provide an acceleration sensor; instead, the sensor, which is present in a braking assistance device, is itself used to sense the emergency braking situation. As a result, it is then possible according to the invention to use, as a trigger for the warning, the action which triggers the strong braking deceleration instead of the effect of an applied braking process by means of a separate acceleration sensor whose signal is in some cases difficult to evaluate. Correspondingly, according to the invention, the abrupt, sudden intensive activation of the brake pedal is used as a trigger for the warning of drivers of vehicles traveling behind. This sudden and intensive activation of the brake pedal, which is typical of an emergency braking situation, is sensed by the braking assistance device, which is connected to the warning device or by its sensor in order to determine an emergency braking situation, and used immediately, and thus without delay and without the risk of incorrect measurement or misinterpretation, by a separate, remote acceleration sensor, to trigger the warning device. As a result it is possible to ensure that a warning, in particular for drivers of vehicles traveling behind, is issued in an emergency braking situation in a very simple, secure and reliable way.

It has proven particularly advantageous to embody the control unit of the braking assistance device in such a way that it forms, with the control unit for controlling the warning device, a common control unit which is arranged in a common housing and carries out both the braking assistance function as well as at the same time carrying out the warning function in a controlling fashion. This embodiment proves particularly advantageous since there is no need for additional lines between the sensor for sensing the emergency braking situation of the braking assistance device and the control unit for the warning device. The connection which the braking assistance device requires between the associated sensor and the control device for the braking assistance device is sufficient. As a result, it is possible to improve the susceptibility of the entire system composed of the warning device and the braking assistance device and at the same time to optimize its installation characteristics and cost.

It has proven particularly advantageous, in addition to other possibilities, to use the existing flashing indicator lights as hazard warning lights or as warning signal transmitters. A very simple and effective arrangement has proven to be to use all the flashing indicator lights at the same time to issue a warning since, as a result, a secure warning is ensured in all directions around the vehicle. This makes a complex and possibly susceptible selection of individual flashing indicator lights unnecessary. As an alternative it has proven appropriate to select individual flashing indicator lights in a targeted fashion to output the warning signal. It has proven appropriate in particular in a normal emergency braking situation without skidding and the possible associated turning of the vehicle to actuate the two rear brake lights in a targeted fashion but not to actuate the two front brake lights. This ensures that the traffic traveling behind is provided with selective information by the warning device. Furthermore it has also proven appropriate to select individual flashing indicator lights in a targeted fashion in particular as a function of the steering wheel lock and the braking situation as warning signal transmitters which output the warning signal. For example it has proven appropriate in the case of a severe steering wheel lock to the left to select the two left-hand flashing indicator lights or only the rear left-hand flashing indicator light in a targeted fashion and not to activate the other, in right-hand flashing indicator lights. This targeted selection of individual flashing indicator lights or of a plurality of flashing indicator lights as warning signal transmitters ensures that the traffic aroundabout, in particular the traffic traveling behind, is provided with a differentiated warning which is adapted to the situation without the latter being excessively burdened by the large number of warning signals and thus overloaded.

It has proven particularly advantageous to use the flashing indicator light as a warning signal transmitter and to actuate it in such a way that the flashing frequency of the warning signal is selected to be significantly different from the flashing frequency of the usual direction indicator signal. The different flashing frequency ensures a reliable differentiation of the warning signal of the warning device compared to the simple direction indicator signal. This differentiation is all the clearer and all the more suitable the greater the difference between the frequencies selected. A flashing frequency for the warning signal in the range from 2 to 4 times the usual flashing frequency for the direction indicator signal has proven particularly advantageous. This doubled or quadrupled flashing frequency of the warning signal can be implemented in a technically very simple way, as a result of which a very reliable and robust warning device according to the invention is provided. This is characterized in particular by the use of existing components such as the flashing indicator lights, i.e. without additional susceptible warning signal transmitters as well as also by simple, effective and efficient actuation of the flashing indicator lights, for example by simply doubling or quadrupling the flashing frequency as a warning signal. This embodiment provides a very reliable and secure warning of the traffic aroundabout, in particular of the drivers of the vehicles traveling behind in situations with strong braking deceleration as a result of the combination of the warning device with the braking assistance function and the particular selection of the warning signal transmitters as flashing indicator lights in conjunction with the selection of the multiple flashing direction indicator frequency which is typical.

In addition to the selection of an increased flashing frequency as a warning signal it has also proven appropriate to make a lower selection for the flashing frequency, in particular significantly lower in the vicinity of a third or of half the usual flashing direction indicator frequency. The significant difference between the usual flashing direction indicator frequency and the flashing frequency of the warning signal ensures that the warning signal is reliably recognized in contrast to the flashing direction indicator signal. In addition to the use of the flashing indicator lights as warning signal transmitters it has likewise proven appropriate to use other lights of the motor vehicle as visual warning signal transmitters. In this context, these other lights can be used either as an alternative to or in addition to the flashing indicator lights. These other flashing indicator lights are preferably also used with a noticeable flashing frequency in this context.

These inventive embodiments of the warning devices in a motor vehicle ensure that the traffic aroundabout, whether road users of vehicles traveling behind or other road users, are provided with information in situations with strong braking deceleration in a particularly secure and reliable fashion.

1-7. (canceled)

8. A motor vehicle having a warning device for drivers of vehicles traveling behind in situations with strong braking deceleration, comprising:
a warning signal transmitter,
a sensor for sensing a situation with strong braking deceleration,
a control unit for controlling the warning device, and
a braking assistance device to which the warning device is connected,
wherein the sensor for sensing a situation with strong braking deceleration is a sensor of the braking assistance device.

9. The motor vehicle having a warning device as claimed in claim 8, wherein the control unit for controlling the warning device forms a common control unit in a common housing with a control unit of the braking assistance device.

10. The motor vehicle having a warning device as claimed in claim 8, wherein the warning signal transmitter comprises at least one flashing indicator.

11. The motor vehicle having a warning device as claimed in claim 10, wherein the warning signal transmitter is formed by the rear flashing indicators.

12. The motor vehicle having a warning device as claimed in claim 10, wherein the warning signal transmitter is formed by all flashing indicators.

13. The motor vehicle having a warning device as claimed in claim 10, wherein the control unit for controlling the warning device actuates the at least one flashing indicator in such a way that its flashing frequency is higher than a flashing frequency for a direction indicator signal in said situation with strong braking deceleration.

14. The motor vehicle having a warning device as claimed in claim 13, wherein the flashing frequency in situations with said strong braking deceleration is selected to be in a range of 2 to 4 times higher than the flashing frequency for the direction indicator signal.

15. The motor vehicle having a warning device as claimed in claim 9, wherein the warning signal transmitter comprises at least one flashing indicator.

16. The motor vehicle having a warning device as claimed in claim 15, wherein the warning signal transmitter is formed by the rear flashing indicators.

17. The motor vehicle having a warning device as claimed in claim 15, wherein the warning signal transmitter is formed by all flashing indicators.

18. The motor vehicle having a warning device as claimed in claim 11, wherein the control unit for controlling the warning device actuates the at least one flashing indicator in such a way that its flashing frequency is higher than a flashing frequency for a direction indicator signal in said situation with strong braking deceleration.

19. The motor vehicle having a warning device as claimed in claim 12, wherein the control unit for controlling the warning device actuates the at least one flashing indicator in such a way that its flashing frequency is higher than a flashing frequency for a direction indicator signal in said situation with strong braking deceleration.

20. A process of operating a warning device of a motor vehicle, the warning device being for drivers of vehicles traveling behind in situations with strong braking deceleration, the motor vehicle and the warning device having a warning signal transmitter, a sensor for sensing a situation with strong braking deceleration, a control unit for controlling the warning device, and a braking assistance device to which the warning device is connected, comprising:
sensing a situation with said strong braking deceleration with a sensor of the braking device, and
transmitting a warning signal with said warning signal transmitter.
